(19) United States
(12) Patent Application Publication
(10) Pub. No.: US 2010/0332762 A1
(43) Pub. Date: Dec. 30, 2010

(54) DIRECTORY CACHE ALLOCATION BASED ON SNOOP RESPONSE INFORMATION

(76) Inventors: Adrian C. Moga, Portland, OR (US); Malcolm H. Mandviwalla, Hillsboro, OR (US); Stephen R. Van Doren, Portland, OR (US)

Correspondence Address: Caven & Aghevli LLC;c/o CPA Global, P.O. BOX 52050, MINNEAPOLIS, MN, 55402, US

(21) Appl. No.: 12/495,722

(22) Filed: Jun. 30, 2009

(51) Int. Cl. G06F 12/08; G06F 12/00

(52) U.S. Cl. 711/129; 711/146; 711/E12.001; 711/E12.033; 711/E12.041

(57) ABSTRACT

Methods and apparatus relating to directory cache allocation that is based on snoop response information are described. In one embodiment, an entry in a directory cache may be allocated for an address in response to a determination that another caching agent has a copy of the data corresponding to the address. Other embodiments are also disclosed.

### FIELD

The present disclosure generally relates to the field of electronics. More particularly, an embodiment of the invention relates to directory cache allocation that is based on snoop response information.

### BACKGROUND

Cache memory in computer systems may be kept coherent using a snoopy bus or a directory based protocol. In either case, a memory address is associated with a particular location in the system. This location is generally referred to as the “home node” of a memory address.

In a directory based protocol, processing/caching agents may send requests to a home node for access to a memory address with which a corresponding “home agent” is associated. Accordingly, performance of such computer systems may be directly dependent on how efficiently a corresponding directory based protocol is maintained.

### BRIEF DESCRIPTION OF THE DRAWINGS

The detailed description is provided with reference to the accompanying figures. In the figures, the left-most digit(s) of a reference number identifies the figure in which the reference number first appears. The use of the same reference numbers in different figures indicates similar or identical items.

FIGS. 1 and 4-5 illustrate block diagrams of embodiments of computing systems, which may be utilized to implement various embodiments discussed herein.

FIG. 2 illustrates entries of a directory cache according to an embodiment.

FIG. 3 illustrates a flow diagram according to an embodiment.

### DETAILED DESCRIPTION

In the following description, numerous specific details are set forth in order to provide a thorough understanding of various embodiments. However, some embodiments may be practiced without the specific details. In other instances, well-known methods, procedures, components, and circuits have not been described in detail so as not to obscure the particular embodiments.

Some embodiments discussed herein are generally related to allocation policy for a directory cache (also referenced herein as “Dir$”). The use of such policies may increase performance and/or save design budget by reducing the size of directory cache(s). The directory cache (which may be on the same integrated circuit die with a home agent in an embodiment) stores information about address(es) which may be stored by one or more agents in the system. For example, the cache may indicate which agents may be storing requested data associated with a given address. Accordingly, the directory is assumed to contain information about the caching status of a coherence unit (e.g., cache line or cache block or another portion of a memory or cache) in the system's caching agents, e.g., for the purpose of reducing the snoop traffic such as reducing or avoiding snoop broadcasting. Also, since the directory cache is maintained efficiently, design budget may be reduced through smaller directory cache(s).

Generally, cache memory in computing systems may be kept coherent using a snoopy bus or a directory based protocol. In either case, a memory address is associated with a particular location in the system. This location is generally referred to as the “home node” of the memory address. In a directory based protocol, processing/caching agents may send requests to the home node for access to a memory address with which a “home agent” is associated.

In distributed cache coherence protocols, caching agents may send requests to home agents which control coherent access to corresponding memory spaces. Home agents are, in turn, responsible for ensuring that the most recent copy of the requested data is returned to the requester either from memory or a caching agent which owns the requested data. The home agent may also be responsible for invalidating copies of data at other caching agents if the request is for an exclusive copy, for example. For these purposes, a home agent generally may snoop every caching agent or rely on a directory to track a set of caching agents where data may reside. In some implementations, all read or lookup requests may result in an allocation in a directory cache. As such, how these allocations are done may have a significant effect on overall system performance.

In some embodiments, the directory information may contain one bit per caching agent, indicating the presence or absence (e.g., depending on the implementation “1” or “0”, respectively, or vice versa) of the target data at a caching agent, e.g., as recorded during prior requests or snoop responses originating from a caching agent. In one embodiment, the directory information may be based on a compressed format, where the bits may encode the presence/absence of the target data in a cluster of caching agents and/or other state information (such as shared or exclusive). Regardless of the specific implementation of the directory information, we will refer to it herein as the Presence Vector (PV).

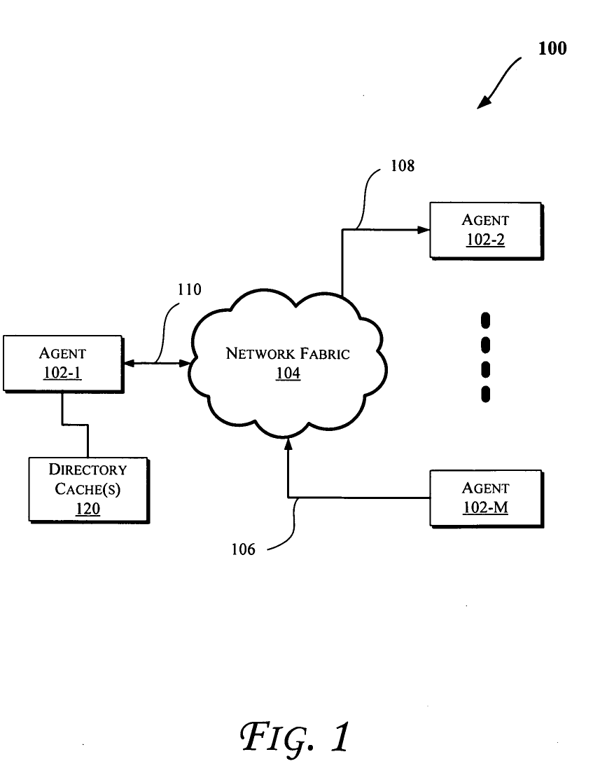

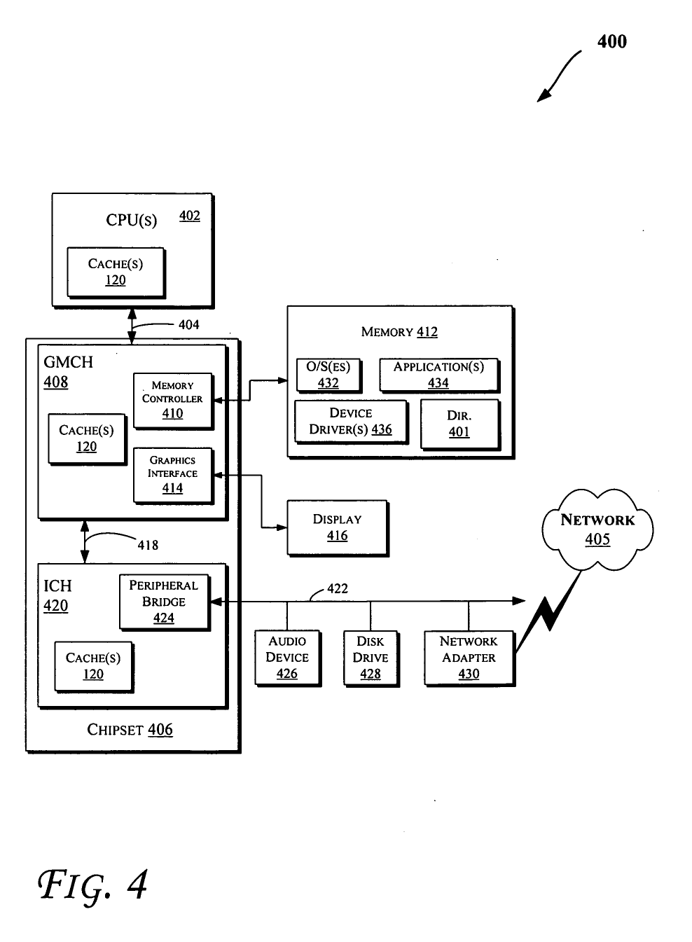

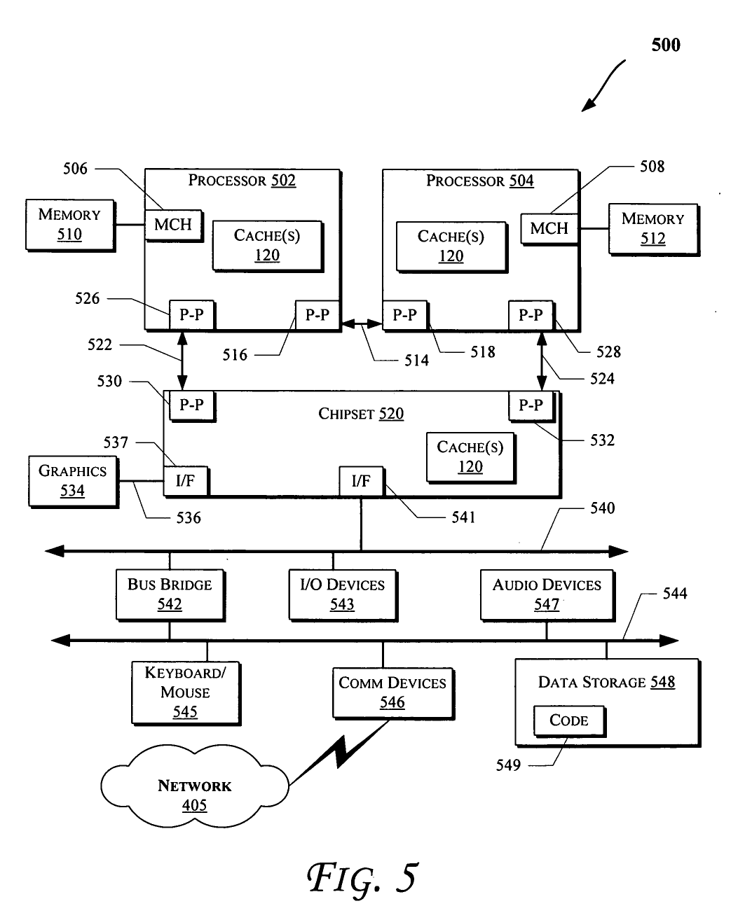

Various computing systems may be used to implement embodiments, discussed herein, such as the systems discussed with reference to FIGS. 1 and 4-5. More particularly, FIG. 1 illustrates a block diagram of a computing system 100, according to an embodiment of the invention. The system 100 may include one or more agents 102-1 through 102-M (collectively referred to herein as “agents 102” or more generally “agent 102”). In an embodiment, one or more of the agents 102 may be any of components of a computing system, such as the computing systems discussed with reference to FIGS. 4-5.

As illustrated in FIG. 1, the agents 102 may communicate via a network fabric 104. In one embodiment, the network fabric 104 may include a computer network that allows various agents (such as computing devices) to communicate data. In an embodiment, the network fabric 104 may include one or more interconnects (or interconnection networks) that communicate via a serial (e.g., point-to-point) link and/or a shared communication network. For example, some embodiments may facilitate component debug or validation on links that allow communication with fully buffered dual in-line memory modules (FBD), e.g., where the FBD link is a serial link for coupling memory modules to a host controller device (such as a processor or memory hub). Debug information may be transmitted from the FBD channel host such that the debug information may be observed along the channel by channel traffic trace capture tools (such as one or more logic analyzers).

In one embodiment, the system 100 may support a layered protocol scheme, which may include a physical layer, a link layer, a routing layer, a transport layer, and/or a protocol layer. The fabric 104 may further facilitate transmission of data (e.g., in form of packets) from one protocol (e.g., caching processor or caching aware memory controller) to another protocol for a point-to-point or shared network. Also, in some embodiments, the network fabric 104 may provide communication that adheres to one or more cache coherent protocols.

Furthermore, as shown by the direction of arrows in FIG. 1, the agents 102 may transmit and/or receive data via the network fabric 104. Hence, some agents may utilize a unidirectional link while others may utilize a bidirectional link for communication. For instance, one or more agents (such as agent 102-M) may transmit data (e.g., via a unidirectional link 106), other agent(s) (such as agent 102-2) may receive data (e.g., via a unidirectional link 108), while some agent(s) (such as agent 102-1) may both transmit and receive data (e.g., via a bidirectional link 110).

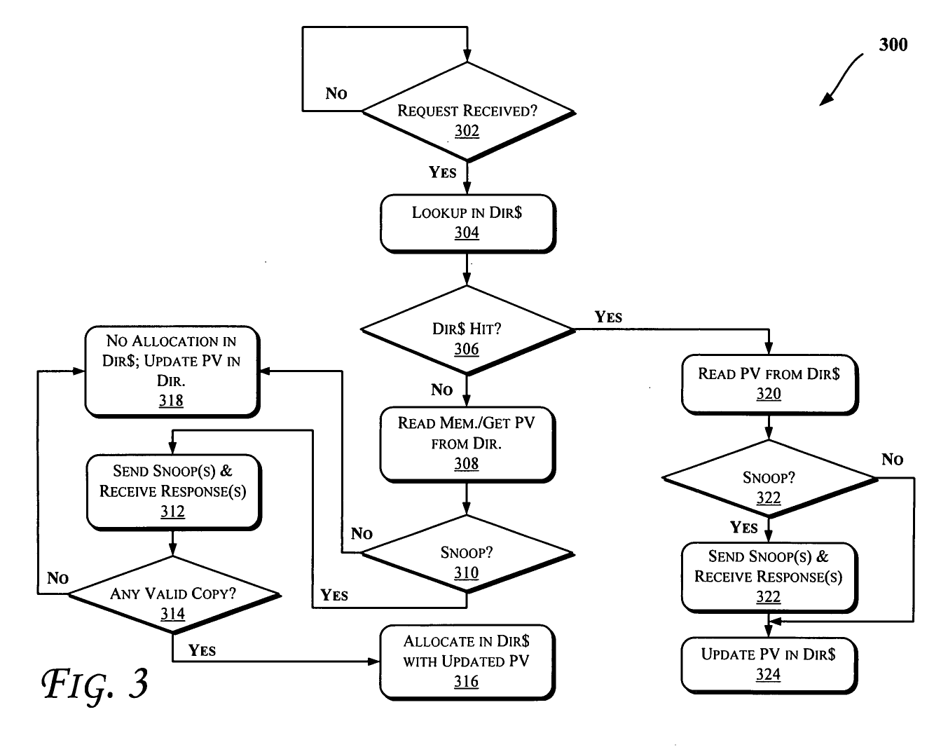

Additionally, at least one of the agents 102 may be a home agent and one or more of the agents 102 may be requesting or caching agents as will be further discussed herein, e.g., with reference to FIG. 3. For example, in an embodiment, one or more of the agents 102 (only one shown for agent 102-1) may maintain entries in one or more storage devices (only one shown for agent 102-1, such as directory cache(s) 120, e.g., implemented as a table, queue, buffer, linked list, etc.) to track information about PV. In some embodiments, each or at least one of the agents 102 may be coupled to a corresponding directory cache 120 that is either on the same die as the agent or otherwise accessible by the agent.

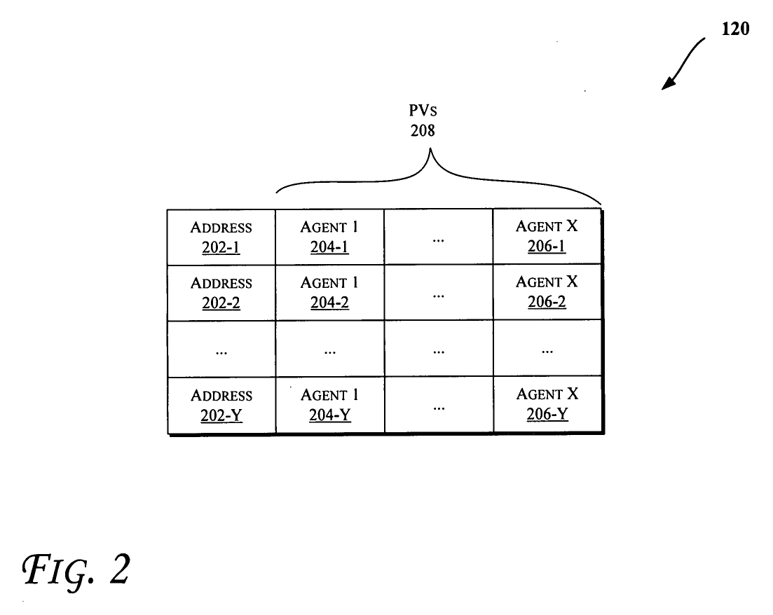

Referring to FIG. 2, a sample directory cache 120 is shown in accordance with one embodiment. As illustrated, the directory cache 120 may store one or more Presence Vectors (PVs) 208 for one or more addresses 202-1 through 202-Y, for example. More particularly, each row of the cache directory 120 may represent a PV for a given address that is stored by agent(s) in a computing system (such as the system 100 discussed with reference to FIG. 1.

In some embodiments, the directory cache 120 may contain one bit (e.g., stored at 204-1 to 206-1, 204-2 to 206-2, through 204-Y to 206Y) per caching agent (e.g., Agent 1, Agent 2, . . . , Agent X), indicating the presence or absence (e.g., depending on the implementation “1” or “0”, respectively, or vice versa) of the target data associated with an address (e.g., addresses 202-1 to 202-Y, respectively) at a given caching agent, e.g., as recorded during prior requests or snoop responses originating from a caching agent. In one embodiment, the directory information may be based on a compressed format, where the bits may encode the presence/absence of the target data in a cluster of caching agents. Regardless of the specific implementation of the directory information, we will refer to it herein as the Presence Vector (PV). Further, in an embodiment, it is assumed that the PV bits have a permanent back-up in memory (e.g., in the ECC (Error Correction Code) bits alongside the coherence unit to which they pertain). However, a permanent backup is not a requirement; neither is the format of a backup entry in memory, but should one exist, the format may be different than the Dir$ PV. For example, in one embodiment, the permanent backup in memory may consist of a single bit, indicating that the address is cached by some unspecified agents or by none.

Additionally, in some embodiments, the PV bits for certain lines may be stored in an on-die directory cache (e.g., on the same die as the home agent). Caching the PV bits on-die may speed up the process of sending out snoop requests by the home agent as will be further discussed herein. In the absence of a directory cache, the PV bits may only be available after a lengthier memory access. In many instances snoop requests may be on the latency-critical path, thus speeding up this process is beneficial for overall system performance. For example, many requests received by a home agent may result in a cache-to-cache transfer where the most recent copy of the data is found in a third-party caching agent. By contrast, there may be instances where the memory copy is clean and no other caching agents need to be snooped. In these instances, obtaining the PV bits from memory presents no additional overhead, as this is done in parallel with the data access itself.

FIG. 3 illustrates a flow diagram of a method 300 to allocate entries in a directory cache, according to an embodiment. In one embodiment, various components discussed with reference to FIGS. 1-2 and 4-5 may be utilized to perform one or more of the operations discussed with reference to FIG. 3. For example, a home agent may perform operations of method 300 in an embodiment.

Referring to FIGS. 1-5, at an operation 302, it may determined whether a request for target data (e.g., identified by an address) has been received by a home agent from another caching agent. At an operation 304, the address of the target data may be looked up in the directory cache (e.g., Dir$ 120). If the directory cache does not include an entry corresponding to the target address, at an operation 308, the home agent may access the main memory (e.g., memory 412 and/or memories 510 or 512) to obtain the PV for the target address from a directory (for example, directory 401) stored in the main memory. In one embodiment, directory 401 stored in the main memory may include the same or similar information as discussed with reference to directory cache 120 about caching agents in the system. In some embodiment, the directory 401 may only include information about a subset of caching agents in the system.

At an operation 310, it may be determined whether a snoop operation is to be performed, e.g., based on the information obtained at operation 308. For example, if the PV obtained from the main memory indicates another caching agent is sharing the target address (e.g., as indicated by the bits corresponding to the target address in the directory 401), at an operation 312, one or more snoops (e.g., to each of the caching agents sharing the target address) may be sent and responses received. For instance, if the request of operation 302 is for a write operation to the target address, copies at other caching agents sharing the target address (per PV of operation 308) may be invalidated. Alternatively, if directory 401 only includes information about a subset of caching agents in the system, a snoop may be broadcast to all caching agents in the subset at operation 312.

If any valid copies exist at operation 314 (e.g., the target address is actually stored by another caching agent than the one that sent the request at operation 302), at an operation 316, an entry is allocated in the directory cache 120. The allocated entry contains updates to the corresponding bits in the PV associated with the target address based on the request and the snoop responses. Otherwise, if no valid copies exist at operation 314, at an operation 318, no allocation is made in the directory cache 120 but the PV in the directory 401 is updated to indicate that the caching agent which sent the request at operation 302 is sharing the target address. Also, as shown in FIG. 3, if no snoop is to be performed at operation 310, the method 300 continues at operation 318.

At operation 306, if it is determined that an entry in the directory cache 120 corresponds to the target address, the PV information is read from the directory cache 120, e.g., to determine which caching agents are sharing the target address. At an operation 322, it may be determined whether a snoop is to be performed, e.g., based on the PV information obtained at operation 320. For example, if the PV information indicates caching agent(s) (e.g., other than the caching agent who sent the request of operation 302) share the same address, one or more snoops may be sent to the caching agent(s) identified by the PV information obtained at operation 320 and responses received. For example, if the request of operation 302 is for a write operation to the target address, copies at other caching agents sharing the target address (per PV of operation 320) may be invalidated at operation 322. At an operation 324, the PV in the directory cache 120 corresponding to the target address is updated (e.g., based on the snoop responses of operation 322 or the type of request of operation 302 (e.g., invalidating other copies if exclusive).

In some embodiments, a directory cache allocation policy is provided which uses sharing information to determine whether the directory cache should allocate an entry for an address. In particular, an embodiment allocates entries for lines or blocks which have a relatively high probability of encountering a future snoop-critical access. By contrast, lines/blocks which have a low probability of snoop-critical accesses may not be allocated. For instance, the heuristic employed by such an embodiment entails that, if a line was stored in the past, it is likely to be stored in the future. Thus, the policy for deciding which entries need to be allocated may use a combination of PV bits and snoop responses. For example, an entry is allocated in the directory cache for an address if the home agent collects at least one snoop response which indicates that another caching agent has a valid copy (e.g., a response forward or downgrade indication). In certain instances, the PV bits will a priori contain the information that no other caching agent needs to be snooped, immediately resulting in a non-allocation decision.

In some embodiments, the allocation policy discussed above may provide more room in the directory cache for entries which are stored or contended by multiple caching agents, for example, where a quick lookup of the PV bits is critical. On the other hand, lines which tend to remain private (accessed by a single caching agent), will miss the directory cache but the directory lookup will not present any latency penalty, as the data and PV bits are accessed simultaneously from memory and the PV bits indicate no need to snoop. Thus, references to lines which do not have to be snooped (such as private data) are part of the effective hits (not true directory cache hits, but also with no impact on performance).

FIG. 4 illustrates a block diagram of an embodiment of a computing system 400. One or more of the agents 102 of FIG. 1 may comprise one or more components of the computing system 400. Also, various components of the system 400 may include a directory cache (e.g., such as directory cache 120 of FIGS. 1-3). The computing system 400 may include one or more central processing unit(s) (CPUs) 402 (which may be collectively referred to herein as “processors 402” or more generically “processor 402”) coupled to an interconnection network (or bus) 404. The processors 402 may be any type of processor such as a general purpose processor, a network processor (which may process data communicated over a computer network 405), etc. (including a reduced instruction set computer (RISC) processor or a complex instruction set computer (CISC)). Moreover, the processors 402 may have a single or multiple core design. The processors 402 with a multiple core design may integrate different types of processor cores on the same integrated circuit (IC) die. Also, the processors 402 with a multiple core design may be implemented as symmetrical or asymmetrical multiprocessors.

The processor 402 may include one or more caches (e.g., other than the illustrated directory cache 120), which may be private and/or shared in various embodiments. Generally, a cache stores data corresponding to original data stored elsewhere or computed earlier. To reduce memory access latency, once data is stored in a cache, future use may be made by accessing a cached copy rather than refetching or recomputing the original data. The cache(s) may be any type of cache, such a level 1 (L1) cache, a level 2 (L2) cache, a level 3 (L3), a mid-level cache, a last level cache (LLC), etc. to store electronic data (e.g., including instructions) that is utilized by one or more components of the system 400. Additionally, such cache(s) may be located in various locations (e.g., inside other components to the computing systems discussed herein, including systems of FIGS. 1 or 5).

A chipset 406 may additionally be coupled to the interconnection network 404. Further, the chipset 406 may include a graphics memory control hub (GMCH) 408. The GMCH 408 may include a memory controller 410 that is coupled to a memory 412. The memory 412 may store data, e.g., including sequences of instructions that are executed by the processor 402, or any other device in communication with components of the computing system 400. Also, in one embodiment of the invention, the memory 412 may include one or more volatile storage (or memory) devices such as random access memory (RAM), dynamic RAM (DRAM), synchronous DRAM (SDRAM), static RAM (SRAM), etc. Nonvolatile memory may also be utilized such as a hard disk. Additional devices may be coupled to the interconnection network 404, such as multiple processors and/or multiple system memories.

The GMCH 408 may further include a graphics interface 414 coupled to a display device 416 (e.g., via a graphics accelerator in an embodiment). In one embodiment, the graphics interface 414 may be coupled to the display device 416 via an accelerated graphics port (AGP). In an embodiment of the invention, the display device 416 (such as a flat panel display) may be coupled to the graphics interface 414 through, for example, a signal converter that translates a digital representation of an image stored in a storage device such as video memory or system memory (e.g., memory 412) into display signals that are interpreted and displayed by the display 416.

As shown in FIG. 4, a hub interface 418 may couple the GMCH 408 to an input/output control hub (ICH) 420. The ICH 420 may provide an interface to input/output (I/O) devices coupled to the computing system 400. The ICH 420 may be coupled to a bus 422 through a peripheral bridge (or controller) 424, such as a peripheral component interconnect (PCI) bridge that may be compliant with the PCIe specification, a universal serial bus (USB) controller, etc. The bridge 424 may provide a data path between the processor 402 and peripheral devices. Other types of topologies may be utilized. Also, multiple buses may be coupled to the ICH 420, e.g., through multiple bridges or controllers. Further, the bus 422 may comprise other types and configurations of bus systems. Moreover, other peripherals coupled to the ICH 420 may include, in various embodiments of the invention, integrated drive electronics (IDE) or small computer system interface (SCSI) hard drive(s), USB port(s), a keyboard, a mouse, parallel port(s), serial port(s), floppy disk drive(s), digital output support (e.g., digital video interface (DVI)), etc.

The bus 422 may be coupled to an audio device 426, one or more disk drive(s) 428, and a network adapter 430 (which may be a NIC in an embodiment). In one embodiment, the network adapter 430 or other devices coupled to the bus 422 may communicate with the chipset 406. Also, various components (such as the network adapter 430) may be coupled to the GMCH 408 in some embodiments of the invention. In addition, the processor 402 and the GMCH 408 may be combined to form a single chip. In an embodiment, the memory controller 410 may be provided in one or more of the CPUs 402. Further, in an embodiment, GMCH 408 and ICH 420 may be combined into a Peripheral Control Hub (PCH).

Additionally, the computing system 400 may include volatile and/or nonvolatile memory (or storage). For example, nonvolatile memory may include one or more of the following: read-only memory (ROM), programmable ROM (PROM), erasable PROM (EPROM), electrically EPROM (EEPROM), a disk drive (e.g., 428), a floppy disk, a compact disk ROM (CD-ROM), a digital versatile disk (DVD), flash memory, a magneto-optical disk, or other types of nonvolatile machine-readable media capable of storing electronic data (e.g., including instructions).

The memory 412 may include one or more of the following in an embodiment: an operating system (O/S) 432, application 434, directory 401, and/or device driver 436. The memory 412 may also include regions dedicated to Memory Mapped I/O (MMIO) operations. Programs and/or data stored in the memory 412 may be swapped into the disk drive 428 as part of memory management operations. The application(s) 434 may execute (e.g., on the processor(s) 402) to communicate one or more packets with one or more computing devices coupled to the network 405. In an embodiment, a packet may be a sequence of one or more symbols and/or values that may be encoded by one or more electrical signals transmitted from at least one sender to at least on receiver (e.g., over a network such as the network 405). For example, each packet may have a header that includes various information which may be utilized in routing and/or processing the packet, such as a source address, a destination address, packet type, etc. Each packet may also have a payload that includes the raw data (or content) the packet is transferring between various computing devices over a computer network (such as the network 405).

In an embodiment, the application 434 may utilize the O/S 432 to communicate with various components of the system 400, e.g., through the device driver 436. Hence, the device driver 436 may include network adapter 430 specific commands to provide a communication interface between the O/S 432 and the network adapter 430, or other I/O devices coupled to the system 400, e.g., via the chipset 406.

In an embodiment, the O/S 432 may include a network protocol stack. A protocol stack generally refers to a set of procedures or programs that may be executed to process packets sent over a network 405, where the packets may conform to a specified protocol. For example, TCP/IP (Transport Control Protocol/Internet Protocol) packets may be processed using a TCP/IP stack. The device driver 436 may indicate the buffers in the memory 412 that are to be processed, e.g., via the protocol stack.

The network 405 may include any type of computer network. The network adapter 430 may further include a direct memory access (DMA) engine, which writes packets to buffers (e.g., stored in the memory 412) assigned to available descriptors (e.g., stored in the memory 412) to transmit and/or receive data over the network 405. Additionally, the network adapter 430 may include a network adapter controller, which may include logic (such as one or more programmable processors) to perform adapter related operations. In an embodiment, the adapter controller may be a MAC (media access control) component. The network adapter 430 may further include a memory, such as any type of volatile/nonvolatile memory (e.g., including one or more cache(s) and/or other memory types discussed with reference to memory 412).

FIG. 5 illustrates a computing system 500 that is arranged in a point-to-point (PtP) configuration, according to an embodiment of the invention. In particular, FIG. 5 shows a system where processors, memory, and input/output devices are interconnected by a number of point-to-point interfaces. The operations discussed with reference to FIGS. 1-4 may be performed by one or more components of the system 500.

As illustrated in FIG. 5, the system 500 may include several processors, of which only two, processors 502 and 504 are shown for clarity. The processors 502 and 504 may each include a local memory controller hub (GMCH) 506 and 508 to enable communication with memories 510 and 512. The memories 510 and/or 512 may store various data such as those discussed with reference to the memory 412 of FIG. 4. As shown in FIG. 5, the processors 502 and 504 (or other components of system 500 such as chipset 520, I/O devices 543, etc.) may also include one or more cache(s) such as those discussed with reference to FIGS. 1-4.

In an embodiment, the processors 502 and 504 may be one of the processors 402 discussed with reference to FIG. 4. The processors 502 and 504 may exchange data via a point-to-point (PtP) interface 514 using PtP interface circuits 516 and 518, respectively. Also, the processors 502 and 504 may each exchange data with a chipset 520 via individual PtP interfaces 522 and 524 using point-to-point interface circuits 526, 528, 530, and 532. The chipset 520 may further exchange data with a high-performance graphics circuit 534 via a high-performance graphics interface 536, e.g., using a PtP interface circuit 537.

In at least one embodiment, the directory cache 120 may be provided in one or more of the processors 502,504 and/or chipset 520. Other embodiments of the invention, however, may exist in other circuits, logic units, or devices within the system 500 of FIG. 5. Furthermore, other embodiments of the invention may be distributed throughout several circuits, logic units, or devices illustrated in FIG. 5.

The chipset 520 may communicate with the bus 540 using a PtP interface circuit 541. The bus 540 may have one or more devices that communicate with it, such as a bus bridge 542 and I/O devices 543. Via a bus 544, the bus bridge 542 may communicate with other devices such as a keyboard/mouse 545, communication devices 546 (such as modems, network interface devices, or other communication devices that may communicate with the computer network 405), audio I/O device, and/or a data storage device 548. The data storage device 548 may store code 549 that may be executed by the processors 502 and/or 504.

In various embodiments of the invention, the operations discussed herein, e.g., with reference to FIGS. 1-5, may be implemented as hardware (e.g., circuitry), software, firmware, microcode, or combinations thereof, which may be provided as a computer program product, e.g., including a machine-readable or computer-readable medium having stored thereon instructions (or software procedures) used to program a computer to perform a process discussed herein. Also, the term “logic” may include, by way of example, software, hardware, or combinations of software and hardware. The machine-readable medium may include a storage device such as those discussed with respect to FIGS. 1-5. Additionally, such computer-readable media may be downloaded as a computer program product, wherein the program may be transferred from a remote computer (e.g., a server) to a requesting computer (e.g., a client) through data signals provided in a carrier wave or other propagation medium via a communication link (e.g., a bus, a modem, or a network connection).

Reference in the specification to “one embodiment” or “an embodiment” means that a particular feature, structure, or characteristic described in connection with the embodiment may be included in at least an implementation. The appearances of the phrase “in one embodiment” in various places in the specification may or may not be all referring to the same embodiment.

Also, in the description and claims, the terms “coupled” and “connected,” along with their derivatives, may be used. In some embodiments of the invention, “connected” may be used to indicate that two or more elements are in direct physical or electrical contact with each other. “Coupled” may mean that two or more elements are in direct physical or electrical contact. However, “coupled” may also mean that two or more elements may not be in direct contact with each other, but may still cooperate or interact with each other.

Thus, although embodiments of the invention have been described in language specific to structural features and/or methodological acts, it is to be understood that claimed subject matter may not be limited to the specific features or acts described. Rather, the specific features and acts are disclosed as sample forms of implementing the claimed subject matter.

1. An apparatus comprising:
a first agent to receive a request, corresponding to a target address, from a second agent; and
a directory cache, coupled to the first agent, to store data corresponding to a plurality of caching agents coupled to the first agent, wherein the stored data is to indicate which one of the plurality of caching agents has a copy of the data corresponding to the target address,
wherein an entry for the target address is to be allocated in the directory cache in response to a determination that another caching agent from the plurality of caching agents has a copy of the data corresponding to the target address.

2. The apparatus of claim 1, wherein the first agent is to update the directory cache in response to one or more snoop responses received from one or more of the plurality of caching agents.

3. The apparatus of claim 1, wherein the first agent is to determine whether an entry, corresponding to the target address, exists in the directory cache in response to receipt of the request.

4. The apparatus of claim 1, further comprising a memory to store a directory, wherein the directory is to store data corresponding to at least a portion of the plurality of caching agents, wherein the first agent is to determine whether an entry, corresponding to the target address, exists in the directory in response to an absence of an entry, corresponding to the target address, in the directory cache.

5. The apparatus of claim 4, wherein the first agent is to update the directory based on the request in response to a determination that no entry, corresponding to the target address, exists in the directory.

6. The apparatus of claim 1, wherein the first agent is to send one or more snoops to one or more of the plurality of caching agents identified by the directory cache to have a copy of the data corresponding to the target address.

7. The apparatus of claim 1, wherein, in response to a determination that an entry, corresponding to the target address, exists in the directory cache, the first agent is to determine whether to send a snoop to one or more of the plurality of caching agents that are identified by the directory cache as having a copy of the data corresponding to the target address.

8. The apparatus of claim 1, wherein the first agent is a home agent of the target address.

9. The apparatus of claim 1, further comprising a serial link to couple the first agent and second agent.

10. The apparatus of claim 1, wherein the first agent and the second agent are on a same integrated circuit die.

11. A method comprising:
receiving a request, corresponding to a target address, at a first agent; and
allocating an entry for the target address in the directory cache in response to a determination that another caching agent from a plurality of caching agents, coupled to the first agent, has a copy of the data corresponding to the target address.

12. The method of claim 11, further comprising storing data in the directory cache to indicate which one of the plurality of caching agents has a copy of the data corresponding to the target address.

13. The method of claim 11, further comprising update the directory cache in response to one or more snoop responses received from one or more of the plurality of caching agents.

14. The method of claim 11, further comprising determining whether an entry, corresponding to the target address, exists in the directory cache in response to receipt of the request.

15. The method of claim 11, further comprising:
storing a directory in a memory, wherein the directory is to store data corresponding to at least a portion of the plurality of caching agents; and
determining whether an entry, corresponding to the target address, exists in the directory in response to an absence of an entry, corresponding to the target address, in the directory cache.

16. The method of claim 11, further comprising sending one or more snoops to one or more of the plurality of caching agents identified by the directory cache to have a copy of the data corresponding to the target address.

17. A system comprising:
a memory to store a directory;
a first agent to receive a request, corresponding to a target address; and
a directory cache, coupled to the first agent, to store data corresponding to a plurality of caching agents coupled to the first agent, wherein the stored data is to indicate which one of the plurality of caching agents has a copy of the data corresponding to the target address,
wherein the directory is to store data corresponding to at least a portion of the plurality of caching agents and wherein an entry for the target address is to be allocated in the directory cache in response to a determination that another caching agent from the plurality of caching agents has a copy of the data corresponding to the target address.

18. The system of claim 17, wherein the first agent is to update the directory cache in response to one or more snoop responses received from one or more of the plurality of caching agents.

19. The system of claim 17, wherein the first agent is to send one or more snoops to one or more of the plurality of caching agents identified by the directory cache to have a copy of the data corresponding to the target address.

20. The system of claim 17, further comprising an audio device coupled to the first agent.
